(19) United States
(12) Patent Application Publication
(10) Pub. No.: US 2014/0009340 A1
(43) Pub. Date: Jan. 9, 2014

(54) ASYMMETRIC RANGING PROCESSING

(71) Applicants: James Chester Meador, Berkeley, CA (US); Siddharth Mohan, San Diego, CA (US)

(72) Inventors: James Chester Meador, Berkeley, CA (US); Siddharth Mohan, San Diego, CA (US)

(73) Assignee: QUALCOMM Incorporated, San Diego, CA (US)

(21) Appl. No.: 13/544,850

(22) Filed: Jul. 9, 2012

(51) Int. Cl. G01S 3/02

(52) U.S. Cl. 342/458

(57) ABSTRACT

Processing associated with ranging operations is shifted from a first apparatus to a second apparatus. For example, upon sampling a received ranging signal (e.g., a pulse) from the second apparatus, the first apparatus does not process the ranging signal to identify a relatively precise time of arrival estimate. Instead, the first apparatus sends sample data (e.g., representative of the power and/or magnitude of the received signal) and associated timestamp information to the second apparatus. The second apparatus processes the received sample data and timestamp information to determine the time of arrival estimate on behalf of the first apparatus. The second apparatus then uses this time of arrival estimate to determine the distance between the apparatuses.

### BACKGROUND

1. Field

This application relates generally to wireless communication and more specifically, but not exclusively, to ranging operations.

2. Introduction

Distance ranging involves, in some aspects, using radio-frequency (RF) signaling or some other type of signaling (e.g., optical signaling) to determine (e.g., estimate) a distance between two apparatuses. The apparatuses cooperate to determine the amount of time it takes for a signal to propagate between the apparatuses and then determine the distance based on this signal propagation time and the known propagation speed of the signal (e.g., estimated as the speed of light). For convenience, the discussion that follows refers to distance ranging simply as ranging.

Two common examples of ranging are one-way ranging and two-way ranging. In a typical one-way ranging scheme, the apparatuses have synchronized timing. In this case, a first apparatus will transmit a signal to a second apparatus and transmit an indication of the time at which the first apparatus transmitted the signal. The second apparatus determines the time at which it receives the signal. One or both of these apparatuses will then determine the signal propagation time based on the time that the first apparatus transmitted the signal and the time that the second apparatus received the signal, and determine the distance between the first and second apparatuses based on this signal propagation time.

A two-way ranging scheme may be employed, for example, in cases where the apparatuses are not synchronized. In such a scheme, a first apparatus sends a first signal to the second apparatus and, in response, the second apparatus sends a second signal to the first apparatus. The round-trip propagation time equals the total round-trip time minus the turnaround time at the second apparatus. The total round-trip time is the duration from the time the first apparatus transmits the first signal to the time the first apparatus receives the second signal. The turnaround time is the duration between the time the second apparatus receives the first signal and the time the second apparatus transmits the second signal. Thus, to determine the round-trip time, each apparatus records the time at which that apparatus transmits a signal to the other apparatus and the time at which that apparatus receives a signal from the other apparatus.

In either of the above ranging schemes, at least one apparatus processes a signal received from the other apparatus to determine (e.g., estimate) the time of arrival of the signal. For example, in some implementations, an apparatus acquires several samples of a received pulse, generates timestamp information indicative of the timing of the samples, and processes the sample data and timing information to generate a relatively accurate estimate of the time of arrival of a leading edge of the pulse.

In practice, these signal processing operations may consume a relatively large amount of power, particularly in the context of mobile devices that are designed to consume as little power as possible. Accordingly, a need exists for improved ranging techniques that use power more effectively than conventional ranging techniques.

### SUMMARY

A summary of several sample aspects of the disclosure follows. This summary is provided for the convenience of the reader and does not wholly define the breadth of the disclosure. For convenience, the term some aspects may be used herein to refer to a single aspect or multiple aspects of the disclosure.

The disclosure relates in some aspects to offloading processing associated with ranging operations from a first type of apparatus to a second type of apparatus. In such a processing offload scheme, two different types of apparatuses are statically or dynamically configured to handle ranging processing operations in an asymmetric manner.

For example, when a first apparatus samples a ranging signal (e.g., a pulse) received from a second apparatus, the first apparatus sends the sample data and associated timestamp information to the second apparatus instead of processing the ranging signal to generate a relatively precise time of arrival estimate. In a typical implementation, this sample data is representative of the power and/or amplitude of the received signal. The second apparatus processes the received sample data and timestamp information to determine the time of arrival estimate on behalf of the first apparatus. The second apparatus then uses this time of arrival estimate to determine the distance between the apparatuses.

A processing offload scheme as taught herein may be employed, for example, in scenarios where the first apparatus has more restrictive resource constraints and/or time constraints than the second apparatus. In some cases, a constrained resource relates to the available power for the apparatus. For example, portable apparatuses powered by a relatively small battery are power constrained as compared to apparatuses powered by utility power. In some cases, a constrained resource relates to the available processing capability of the apparatus. For example, a relatively low cost apparatus may have fewer processing resources (e.g., a slower processor or no processor) than other apparatuses. A resource may relate to other factors as well (e.g., connectivity, context, etc.). Furthermore, a decision to offload processing to another apparatus may be based on more than one constraint (e.g., resource and/or time). By offloading processing to an apparatus with better resources, one or more factors (e.g., cost, battery life, complexity, etc.) associated with the constrained node are improved.

In some embodiments, an apparatus will compress ranging-related data (e.g., sample data and/or timestamp information) before transmitting the data to another apparatus. For example, data compression is typically employed if the resource usage (e.g., power consumption) associated with compressing the data and transmitting the compressed data is less than the resource usage associated with transmitting the uncompressed data to the other apparatus.

In view of the above, an apparatus, method, or computer-program product implemented in accordance with the teachings herein may provide or be used to provide ranging functionality. In some aspects, such functionality relates to: receiving a signal from a second apparatus at a first apparatus; sampling the signal to generate data that is representative of timing and magnitude of the received signal; and transmitting the generated data from the first apparatus to the second apparatus to enable the second apparatus to determine a distance between the first apparatus and the second apparatus. In other aspects, such functionality relates to: transmitting a signal from a second apparatus to a first apparatus; receiving data from the first apparatus at the second apparatus, wherein the received data is representative of timing and magnitude of the signal as received by the first apparatus; and determining a distance between the first apparatus and the second apparatus based on the received data.

### BRIEF DESCRIPTION OF THE DRAWINGS

These and other sample aspects of the disclosure will be described in the detailed description and the appended claims that follow, and in the accompanying drawings, wherein:

FIG. 1 is a simplified block diagram of an example of communication system that employs asymmetric ranging processing;

FIG. 2 is a simplified messaging flow diagram illustrating an example of offloading ranging operations;

FIG. 3 is a flowchart of several sample operations performed by an apparatus to offload ranging operations to another apparatus;

FIG. 4 is a flowchart of several sample operations performed by an apparatus to perform ranging operations offloaded by another apparatus;

FIG. 5 is a flowchart of several sample operations performed in conjunction with the use of multiple power states for ranging operations;

FIG. 6 is a simplified signaling and messaging flow diagram illustrating an example of offloading operations for two-way ranging;

FIG. 7 is a simplified signaling and messaging flow diagram illustrating another example of offloading operations for two-way ranging;

FIG. 8 is a simplified signaling and messaging flow diagram illustrating an example of offloading operations for one-way ranging;

FIG. 9 is a simplified diagram illustrating an example of detection of a leading edge of a pulse;

FIG. 10 is a simplified block diagram of several sample components that may be employed in communication apparatuses;

FIG. 11 is a simplified block diagram of several sample aspects of communication components; and

FIGS. 12 and 13 are simplified block diagrams of several sample aspects of apparatuses configured to support ranging as taught herein.

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

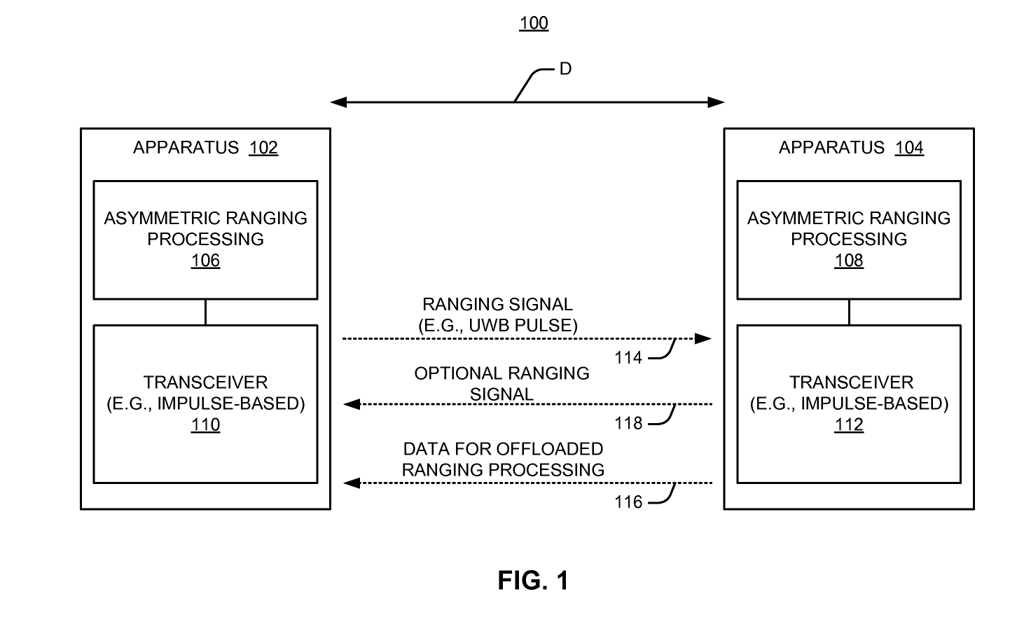

FIG. 1 illustrates a communication system 100 including apparatuses 102 and 104 that are currently separated by a distance D. In accordance with the teachings herein, the apparatuses 102 and 104 employ asymmetric ranging processing 106 and 108 whereby ranging processing that would conventionally be performed by the apparatus 104 is instead offloaded to the apparatus 102.

The apparatuses 102 and 104 include respective transceivers 110 and 112 for transmitting and receiving ranging signals and other types of communication signaling (e.g., messages). The apparatuses 102 and 104 may be implemented in various ways. In some implementations, the apparatuses 102 and 104 comprise wireless devices (e.g., nodes) that transmit RF signals over-the-air. In other implementations, the apparatuses may transmit other types of signals (e.g., optical signals). In a typical embodiment, the transceivers are low power ultra-wideband (UWB) pulse-based transceivers that generate and receive UWB pulses and thereby enable very accurate (e.g., sub-foot precision) ranging.

The ranging processing 106 of the apparatus 102 cooperates with the transceiver 110 to transmit signals to and receive signals from the apparatus 104. For example, the apparatus 102 may send a message to the apparatus 104 to request initiation of a ranging operation and transmit a ranging signal 114 for distance determination (e.g., estimation). In the case of an impulse-based transceiver 110, the transceiver 110 sends these signals and/or messages via one or more pulses (e.g., UWB pulses).

Similarly, the ranging processing 108 of the apparatus 104 cooperates with the transceiver 112 to transmit signals to and receive signals from the apparatus 102. For example, the apparatus 104 may send a message 116 to the apparatus 102 to respond to a ranging request and, optionally (e.g., if two-way ranging is employed), transmit a ranging signal 118 for distance determination. In the case of an impulse-based transceiver 112, the transceiver 112 also sends these signals and/or messages via one or more pulses (e.g., UWB pulses).

In accordance with the teachings herein, instead of processing the ranging signal 114 to determine an accurate estimate of the time of arrival of the ranging signal 114, the apparatus 104 instead samples the received signal to generate data that the apparatus 104 sends to the apparatus 102 for offloaded ranging processing. In this way, the ranging processing 108 of the apparatus 104 can be implemented in a manner that requires fewer resources (e.g., power and/or processing resources) as compared to the ranging processing 106 of the apparatus 102. For example, the apparatus 104 may be a very low power, mobile apparatus where for reasons such as cost, size, complexity, and convenience, it is desired that the apparatus 104 have a very small battery, have minimal processing capabilities, and require little maintenance. In contrast, the apparatus 102 may be a stationary apparatus that is connected to utility power and that does not have the strict resource constraints of the apparatus 104. As a specific example, in some implementations, the apparatus 104 is a trackable, electronic tag (e.g., badge) used for monitoring articles or people while the apparatus 102 is a monitoring base unit that communicates with the electronic tags in its coverage area and determines the location and/or movement of these electronic tags. Preferably, these electronic tags have very small form factors, low cost, and minimal power requirements (e.g., powered by a coin cell battery).

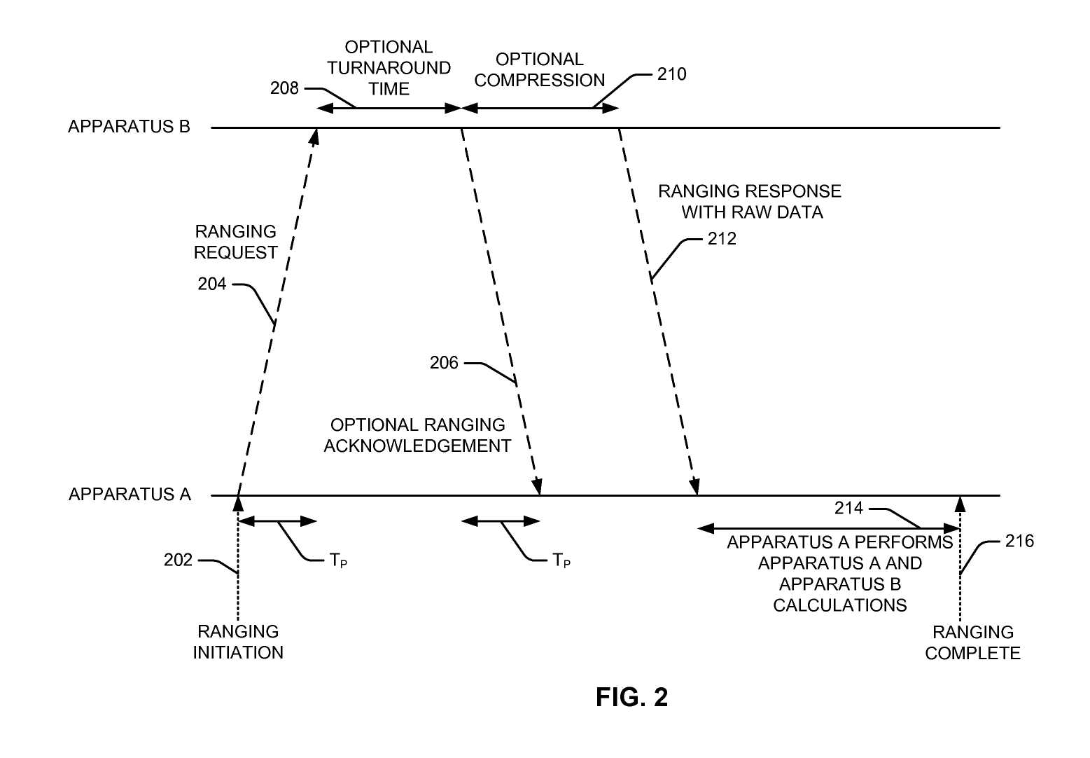

FIG. 2 illustrates in more detail examples of ranging operations that employ offloaded processing. For purposes of illustration, FIG. 2 describes sample operations in the context of one-way ranging and two-way ranging between a pair of apparatuses, referred to as an apparatus A and an apparatus B. It should be appreciated, however, that the teachings herein may be employed with other types of ranging operations.

The apparatus A initiates a ranging operation at a point in time represented by the arrow 202. As discussed in more detail below, in various embodiments, ranging is initiated periodically, on-demand, or in some other manner

The apparatus A transmits a ranging request 204 to the apparatus B. In this example, the ranging request is a packet that comprises a ranging signal (e.g., at a specified section of the packet) that is used to determine the signal propagation time. Thus, the apparatus A records (e.g., timestamps) the time at which it transmits the ranging signal.

The apparatus B receives the ranging request comprising the ranging signal after the unknown (at this point in time) signal propagation time. As discussed herein, rather than processing the received signal to determine a precise time of arrival of the ranging signal at apparatus B, the apparatus B samples all or a portion of the received signal to generate data (referred to herein as raw data) that is to be sent to the apparatus A for processing. In addition, the apparatus B generates an indication of timing associated with the receipt of the ranging signal (e.g., indicating the timing of the sampling used to generate the raw data).

In a two-way ranging implementation, the apparatus B sends a ranging acknowledgement 206 to the apparatus A after a turnaround time (represented by the line 208). The ranging acknowledgement 206 is a packet comprising a ranging signal (e.g., at a specified section of the packet) that is used in conjunction with the ranging signal of the ranging request 204 to determine a round-trip signal propagation time. Thus, the apparatus B records (e.g., timestamps) the time at which it transmits the ranging acknowledgement 206.

As discussed in more detail below, in some implementations, the apparatus B compresses some or all of the data that the apparatus B sends to the apparatus A. For example, in some cases, the apparatus B will compress the raw data and the associated timing indication (and in two-way ranging scenario, the time of transmission of the ranging signal embedded in the ranging acknowledgement 206). Such compression is used, for example, in cases where it is more efficient (e.g., in term of power consumption) to compress the data and transmit the compressed data than it is to simply transmit the uncompressed data. This optional compression operation takes a certain amount of time as represented by the line 210. In such implementations, the apparatuses A and B may each include processing functionality (e.g., a processor or a dedicated compression/decompression circuit) for providing compression-related functionality. For example, this processing functionality will implement a run length encoding algorithm or some other suitable algorithm.

In either the one-way ranging or two-way ranging scenario, the apparatus B transmits a ranging response 212 to the apparatus A. The ranging response 212 includes the raw data and the associated timing data. As mentioned above, in some cases this data is compressed.

Upon receiving the ranging response 212 (and optionally decompressing the data), the apparatus A performs ranging calculations to determine the distance between the apparatuses as represented by the line 214. Of note, in addition to performing its own calculations (e.g., calculating a precise time of arrival of the ranging signal embedded in the ranging acknowledgement 206 in the case of two-way ranging), the apparatus A also performs calculations on behalf of the apparatus B. Specifically, the apparatus A uses the raw data and associated timing data to calculate a precise time of arrival at the apparatus B of the ranging signal embedded in the ranging request 204.

Once the apparatus A obtains the times of transmission and reception for the ranging signal(s), the apparatus A determines the signal propagation time (one-way or round-trip). The apparatus A then determines the distance between the apparatuses based on the signal propagation time. For example, distance may be determined (e.g., estimated) based on the equation: D=T_{P}*C, where D is the determined distance, T_{P} is the signal propagation delay from one apparatus to the other, and C is the speed of light.

For one-way ranging, the apparatus A calculates the one-way signal propagation time T_{P} associated with the ranging request 204. Here, the apparatus A previously recorded the time of transmission of this signal, and the apparatus A calculates the time of arrival of this signal based on the raw data and the associated timing data (e.g., a received timing indication). The apparatus A determines the distance between the apparatuses based on this one-way signal propagation time T_{P} based on the above equation.

For two-way ranging, the apparatus A calculates the round-trip signal propagation time 2T_{P} associated with the ranging request 204 and the ranging acknowledgement 206. The apparatus A obtains the timing information for the ranging request 204 in the same manner discussed above for the one-way case. For the ranging acknowledgement 206, the apparatus A receives the time of transmission via the ranging response 212 and calculates the time of arrival by processing the ranging signal embedded in the received ranging acknowledgement 206. The apparatus A determines the distance between the apparatuses based on the corresponding round-trip signal propagation time 2T_{P} based on the above equation.

The ranging operation is thus complete at this point as represented by the line 216. In some cases, the apparatus A will send the determined distance to the apparatus B (transmission not shown in FIG. 2).

Through the use of asymmetric ranging processing (offloaded ranging processing) as taught herein, resource costs associated with the apparatus from which processing is offloaded may be significantly reduced. For example, power consumption of the apparatus may reduced by a considerable margin (e.g., 2×, 3×, etc.). Also, the number of components employed in the apparatus may be reduced (e.g., by eliminating the need for a microprocessor, ROM, and Flash memory; and by reducing the need for RAM, etc.).

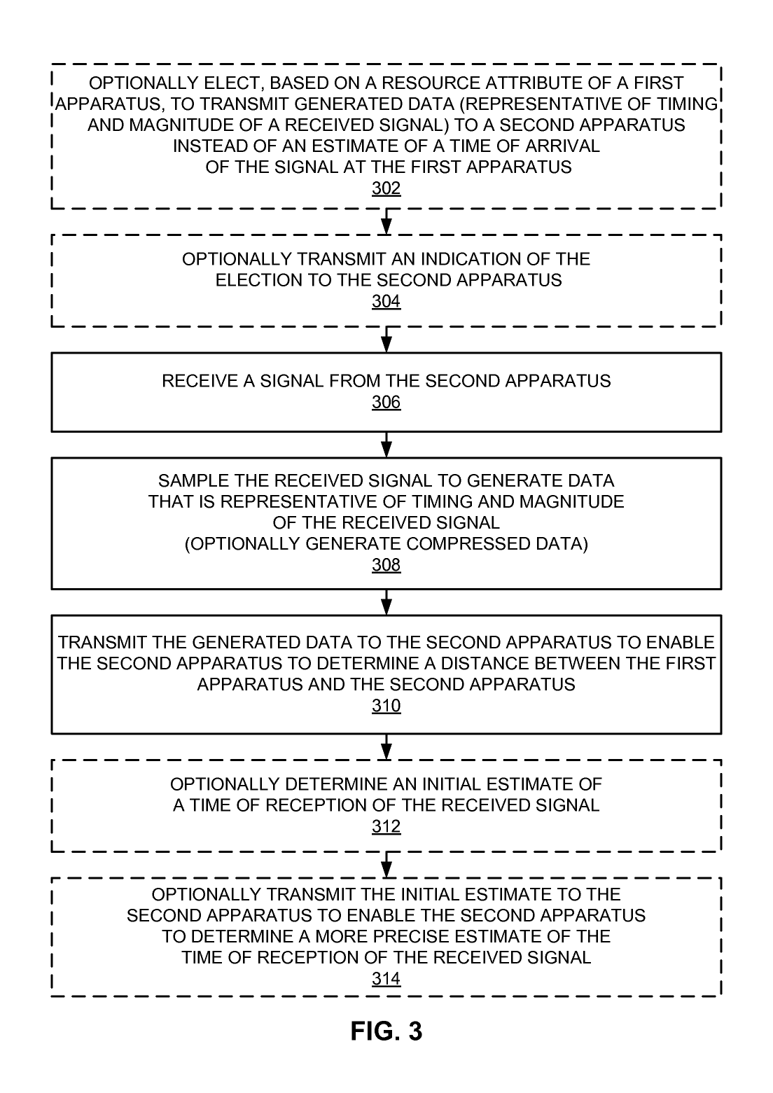

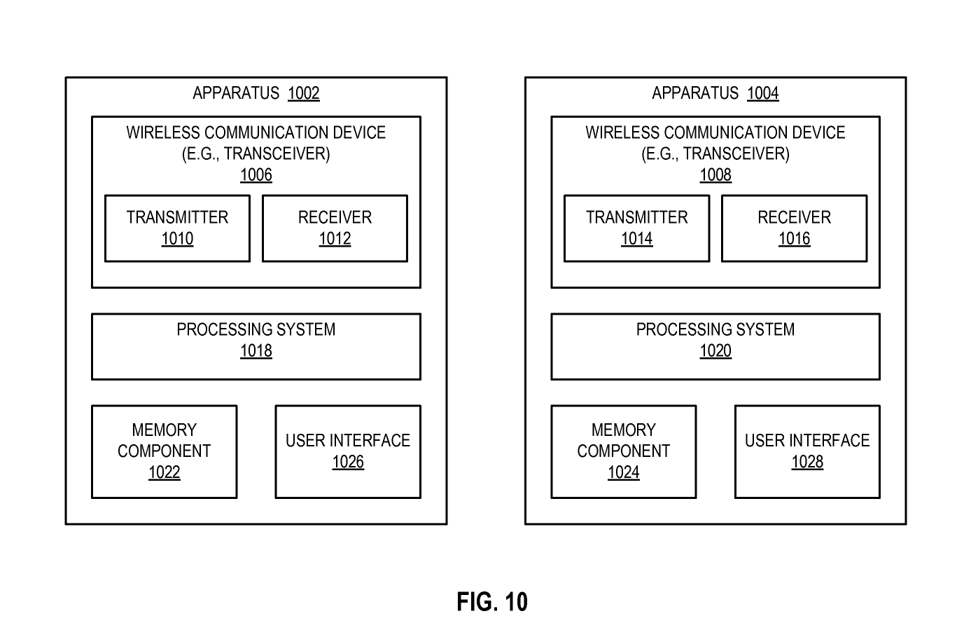

These and other ranging operations will be discussed in more detail in conjunction with the flowcharts of FIGS. 3-5. For convenience, the operations of FIGS. 3-5 (or any other operations discussed or taught herein) may be described as being performed by specific components (e.g., the components of FIG. 1 or FIG. 10). It should be appreciated, however, that these operations may be performed by other types of components and may be performed using a different number of components. It also should be appreciated that one or more of the operations described herein may not be employed in a given implementation.

FIG. 3 describes an example of operations performed by a first apparatus that offloads ranging processing to a second apparatus. Accordingly, the first apparatus may correspond to the apparatus 104 of FIG. 1 or the apparatus B of FIG. 2, while the second apparatus may correspond to the apparatus 102 of FIG. 1 or the apparatus A of FIG. 2.

The first and second apparatuses may be configured to support offloaded ranging in different ways in different implementations. For example, the apparatuses may be pre-configured to support offloaded ranging, may advertise their respective ranging capabilities, or may negotiate how ranging will be performed.

For a pre-configured implementation, an apparatus may always use offloaded ranging and assume that any apparatus with which ranging operations are performed also supports offloaded ranging. For example, a low power apparatus may assume that the other apparatus (e.g., an apparatus powered by utility power) will perform ranging calculations on behalf of the low power apparatus. Conversely, a higher power apparatus may assume that the other apparatus will send raw data for the ranging calculations performed by the higher power apparatus.

For an implementation where the apparatuses advertise their capabilities, an apparatus will transmit a message that informs another apparatus whether it supports offloaded ranging. In some cases, an apparatus will broadcast a message that includes an indication of the apparatus's capabilities. In other cases, an apparatus will include an indication of its capabilities in a message sent to the other apparatus (e.g., during a pairing operation or some other operation). Upon receiving such an indication, the other apparatus will determine whether it is able to conduct ranging operations with the apparatus.

In some implementations, an apparatus is capable of either using offloaded ranging or not using offloaded ranging. For example, in a first mode of operation, a low power apparatus forgoes the time of arrival calculations and instead transmits the raw data. Conversely, in a second mode of operation, the low power apparatus performs the time of arrival calculation and transmits the determined time value to the other apparatus. Similarly, in a first mode of operation, a higher power apparatus calculates a time of arrival on behalf of the other apparatus based on received raw data. In the second mode of operation, the higher power apparatus expects to instead receive the time of arrival value from the other apparatus.

Accordingly, in some implementations, the apparatuses may negotiate to determine which mode of operation will be used. For example, one of the apparatus may request to use offloaded ranging under certain circumstances.

Block 302 of FIG. 3 illustrates an example where the first apparatus is capable of electing whether to use offloaded ranging. In particular, based on a resource attribute of the first apparatus, the first apparatus may elect to transmit generated data to the second apparatus instead of an estimate of a time of arrival of a received ranging signal at the first apparatus. As discussed below, this generated data will be representative of timing and magnitude of the received signal (e.g., a ranging pulse or a set of ranging pulses) and will be processed by the second apparatus on behalf of the first apparatus.

The resource attribute upon which this election is based may take different forms in different implementations. In some cases, the resource attribute relates to a power resource. Here, an apparatus may elect to use offloaded ranging when its power is constrained in some manner (e.g., the current level of available power is below a threshold level). Such a power constraint could arise, for example, when the battery power of the apparatus is low. In some cases, the resource attribute relates to a processing resource. Here, an apparatus may elect to use offloaded ranging whenever the apparatus determines that it has less processing capability than the other apparatus. An apparatus may make an election based on other resource attributes and/or based on more than one resource attribute.

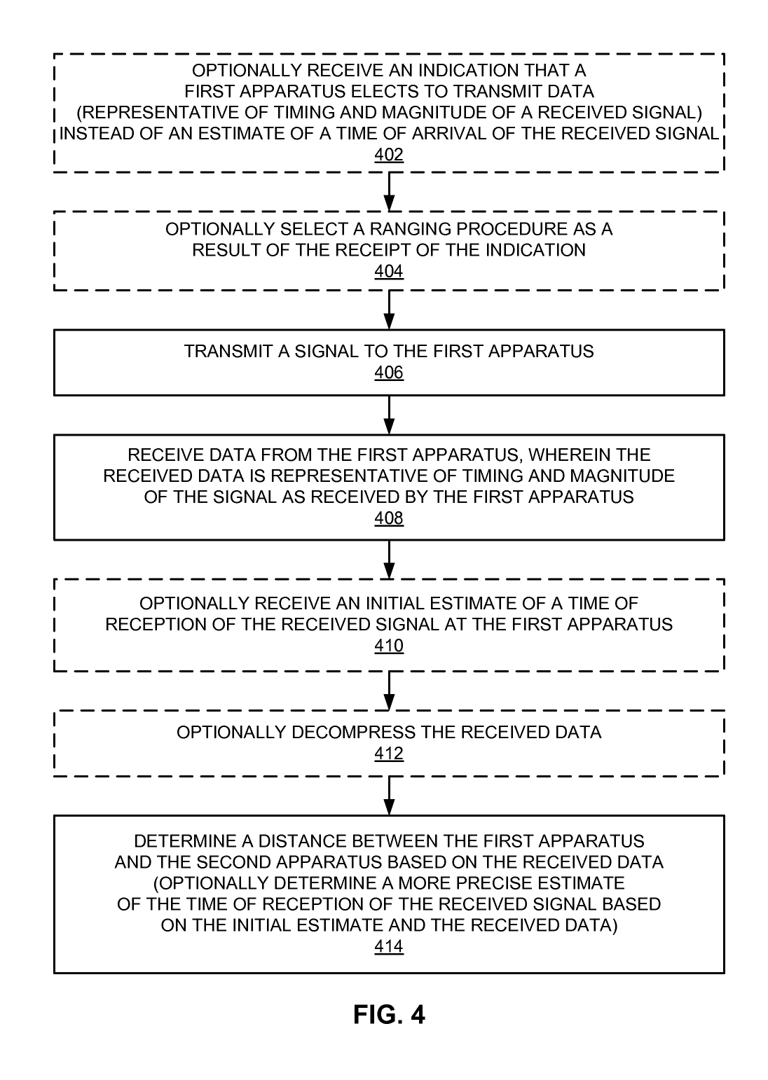

As represented by block 304, in scenarios where the apparatus makes the election of block 302, the apparatus transmits an indication of this election to the second apparatus. As discussed above, the apparatus will broadcast this indication, send the indication in some other type of message, or send the indication in some other manner. As discussed below in conjunction with FIG. 4, the second apparatus may be configured to support offloaded ranging upon receipt of this indication.

In the discussion of the operations of FIG. 3 that follows, the first apparatus supports offloaded ranging. For purposes of this discussion, it is immaterial how the first apparatus is configured for this mode of operation (e.g., pre-configured, negotiated, etc.).

As represented by block 306, at some point in time, the first apparatus receives a signal from the second apparatus. As discussed herein, this signal will comprise a pulse, a set of pulses, or some other type of signal that is conducive to conducting ranging measurements.

As represented by block 308, the first apparatus samples the received signal to generate data that is representative of timing and magnitude of the received signal. For example, the first apparatus samples a pulse at various points in time to generate several sample points. In some implementations, this sampling is multi-bit sampling where the first apparatus generates a number that can take any value of a defined set of three or more values (e.g., −1, 0, +1; or 0, 1, 2, 3; and so on) corresponding to the amplitude for each sample. In some implementations, this sampling is single-bit sampling (e.g., based on a 1-bit analog-to-digital converter) where a binary number (e.g., a 0 or 1) corresponding to the amplitude is generated for each sample. In the latter case, the first apparatus may sample over multiple pulses and/or sample at different thresholds to better characterize the received pulse(s).

In addition, the first apparatus will generate at least one indication of the timing of these samples. In some cases, the first apparatus generates multiple time values (e.g., one for each sample). In other cases, the first apparatus generates a single time value (e.g., indicative of the timing of a designated sample). For example, in cases where the second apparatus knows the sampling interval, the second apparatus can extrapolate the timing of the remaining samples from the single time value.

In view of the above, it should be appreciated that the data generated at block 308 will take various forms in different implementations. In some aspects, the generated data represents a plurality of samples of the received signal. In some aspects, the generated data comprises at least one timestamp corresponding to timing of the plurality of samples. In some aspects, to represent the timing of the received signal, the generated data comprises at least one time value indicative of when the sampling occurred. In some aspects, to represent the magnitude of the received signal, the generated data comprises a plurality of amplitude values of samples generated by the sampling. For example, the amplitude of a received pulse may be represented as a measured value (e.g., any value from a defined minimum value to a defined maximum value, inclusive), as a normalized value (e.g., any value from 0 to 1, inclusive), or in some other suitable manner. In some aspects, to represent the magnitude of the received signal, the generated data comprises a plurality of power values of samples generated by the sampling. For example, the energy of a received pulse may be measured over a period of time (e.g., by an integrating amplifier that receives the samples) and represented as a power value in decibels (dB), as a normalized value, or in some other suitable manner.

In some implementations, the first apparatus compresses the data generated at block 308. Accordingly, in some aspects, the generation of the data comprises compressing a set of data obtained as a result of the sampling. As discussed herein, this set of data comprises sample data representative of a plurality of samples of the received signal, at least one timestamp corresponding to timing of a plurality of samples of the received signal, some other type of information, or a combination of the above types of information.

As represented by block 310, the first apparatus transmits the data generated at block 308 (uncompressed or compressed) to the second apparatus to enable the second apparatus to determine a distance between the first apparatus and the second apparatus. That is, the first apparatus offloads the processing of this data onto the second apparatus.

Referring to blocks 312 and 314, in some implementations, the first apparatus does not completely offload the processing of the received data. For example, as represented by block 312, the first apparatus will determine an initial (e.g., rough) estimate of a time of reception (arrival) of the received signal in some cases. In such a case, the first apparatus transmits the initial estimate to the second apparatus to enable the second apparatus to determine a more precise estimate of the time of reception of the received signal (i.e., the signal received by the first apparatus at block 306). For example, the first apparatus may send an indication of the timing of a designated sample of a set of sampled data generated at block 308. However, the timing of the designated sample may not correspond to the time of arrival of a leading edge of the signal received at block 306. Hence, the first apparatus may offload the precise time of arrival processing to the second apparatus. Upon determining this time of arrival, the second apparatus may correlate the time of arrival to the timing of the designated sample (e.g., to specify the time of arrival relative to a specified time reference such as a timing reference of the first apparatus, system time, or some other reference).

FIG. 4 describes operations performed by a second apparatus that performs ranging processing on behalf of a first apparatus. Thus, in some aspects, the operations of FIG. 4 are complementary to the operations of FIG. 3.

Blocks 402 and 404 relate to an optional implementation where the second apparatus is capable of selecting whether it will support offloaded ranging. Thus, in some aspects, the operations of blocks 402 and 404 are complementary to the operations of blocks 302 and 304 of FIG. 3.

As represented by block 402, the second apparatus receives an indication that the first apparatus elects to transmit the data generated at block 308 to the second apparatus instead of an estimate of a time of arrival of the signal received at block 306. As represented by block 404, as a result of the receipt of the indication at block 402, the second apparatus selects which ranging procedure it will use. In particular, in this case, the second apparatus selects a ranging procedure that determines the distance based on the data representative of timing and magnitude of the signal. Thus, in this case, the second apparatus does not select a ranging procedure that determines the distance based on a received estimate of the time of arrival of the signal at the first apparatus.

In the discussion of the operations of FIG. 4 that follows, the second apparatus supports offloaded ranging. For purposes of this discussion, it is immaterial how the second apparatus is configured for this mode of operation (e.g., pre-configured, negotiated, etc.).

As represented by block 406, at some point in time, the second apparatus transmits a signal to the first apparatus. As discussed herein, this signal will comprise a pulse, a set of pulses, or some other type of signal that is conducive to conducting ranging measurements.

As represented by block 408, as a result of transmitting the signal at block 406, the second apparatus receives data from the first apparatus. In particular, the second apparatus receives the data generated at block 308 of FIG. 3 that is representative of timing and magnitude of the signal (e.g., the pulse(s)) as received by the first apparatus.

In implementations where the first apparatus provides an initial estimate of the time of reception of the received signal, the second apparatus receives this estimate as represented by block 410. That is, the operations of block 410 are complementary to the operations of block 312 and 314 of FIG. 3.

In implementations where the first apparatus sends compressed data to the second apparatus, the second apparatus decompresses this data at block 412.

As represented by block 414, the second apparatus determines a distance between the first apparatus and the second apparatus based on the received data. In some aspects, the determination of the distance comprises determining a time of arrival of the signal at the first apparatus based on the received data, determining a signal propagation time based on a time of the transmission of the signal from the second apparatus and the determined time of arrival, and determining the distance based on the signal propagation time.

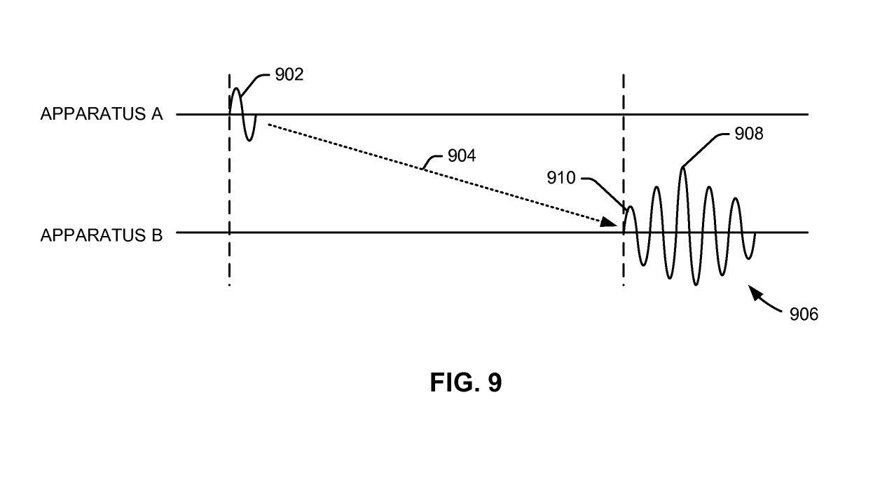

The distance determination of block 414 may involve various operations complementary to the operations described above. In some implementations, if the signal transmitted at block 406 is a pulse, the determination of the distance comprises determining (e.g., estimating) a time of arrival of a leading edge of the pulse at the first apparatus based on the received data. The determination of a time of arrival of a leading edge of a pulse is described in further detail below in conjunction with FIG. 9. In implementations where the data is compressed, the determination of the distance comprises processing the decompressed received data to determine a time of arrival of the signal at the first apparatus. In implementations where the second apparatus receives an initial estimate at block 410, the determine of the distance may involve determining a more precise estimate of the time of reception of the received signal based on this initial estimate and based on the data received at block 408.

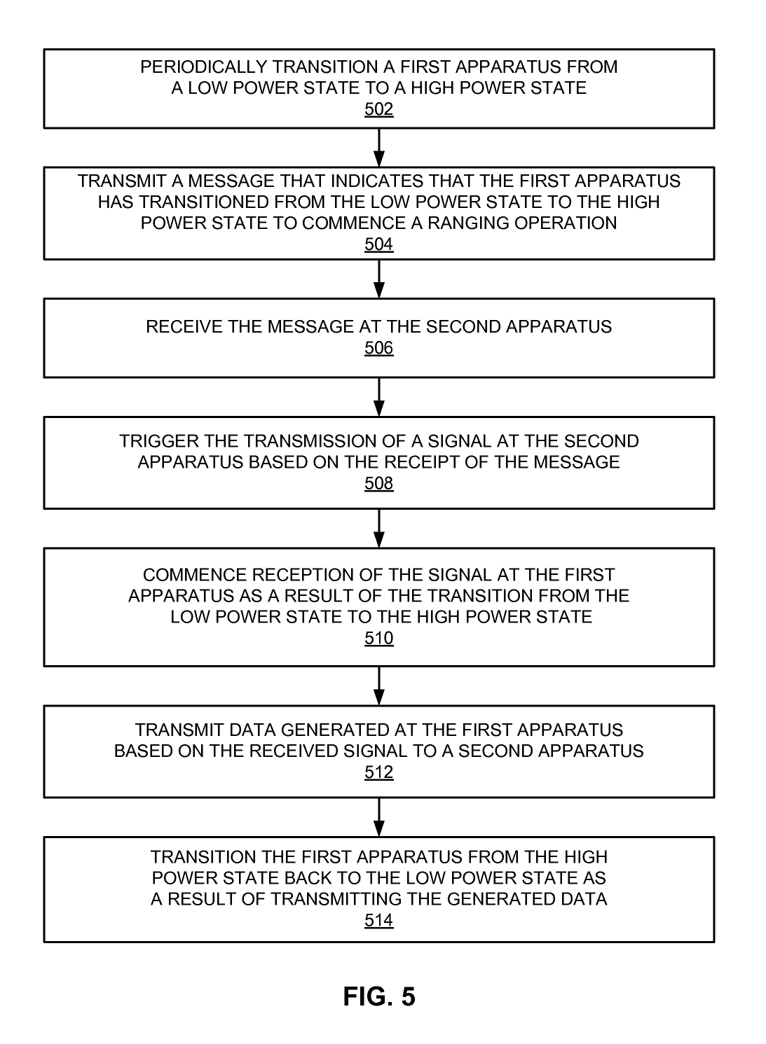

Referring now to FIG. 5, in a typical implementation, a low power apparatus will employ a multi-stage power scheme whereby the apparatus switches between a low power state (or states) and a high power state (i.e., higher than the low power state(s)). For example, the apparatus will be in the low power state (e.g., a sleep state) the majority of the time, but will periodically switch to the high power state (e.g., wake-up) to determine whether it needs to communicate with another apparatus. The power consumption of the apparatus can be reduced considerably through the use of such a power scheme.

FIG. 5 illustrates sample operations performed by a first apparatus that wakes up periodically to determine whether it needs to communicate with a second apparatus to perform a ranging operation. For example, referring to the electronic tag scenario, an electronic tag can remain in a low power state the majority of the time and only switch to the high power state often enough (e.g., every second, every 5 seconds, etc) to provide a desired level of tracking accuracy.

As represented by block 502, the first apparatus periodically transitions from a low power state to a high power state. For example, the first apparatus may “wake-up” at one second intervals to actively scan for signals from the second apparatus for a short period of time (e.g. 100 milliseconds).

In conjunction with this transition, as represented by block 504, the first apparatus may transmit a message that indicates that the first apparatus has made this transition to commence a ranging operation. For example, in some cases, the first apparatus sends a message to the second apparatus that inquires whether a ranging operation is to be commenced. The second apparatus receives this message as represented by block 506.

As represented by block 508, the second apparatus triggers the transmission of the signal of block 406 (FIG. 4) based on the receipt of the message. For example, upon receiving this message, the second apparatus may assume that the first apparatus will be monitoring for ranging signals for a defined period of time before transitioning back to the low power state.

As represented by block 510, the first apparatus commences reception of the signal (e.g., at block 306 of FIG. 3) as a result of transitioning from the low power state to the high power state at block 502. For example, the first apparatus may commence monitoring for ranging signals upon transitioning to the high power state, or the first apparatus may commence monitoring for ranging signals after negotiating with the second apparatus to commence a ranging operation.

As represented by block 512, the first apparatus transmits data (generated at the first apparatus based on the received signal) to the second apparatus. These operations thus correspond to the operations of block 310 of FIG. 3.

As represented by block 514, the first apparatus transitions from the high power state back to the low power state as a result of transmitting the generated data at block 512. That is, since the first apparatus has completed all of the operations it needs to do for the ranging operation (in this particular example), the first apparatus may return to the low power state until the next wake-up time interval (e.g., corresponding to block 502).

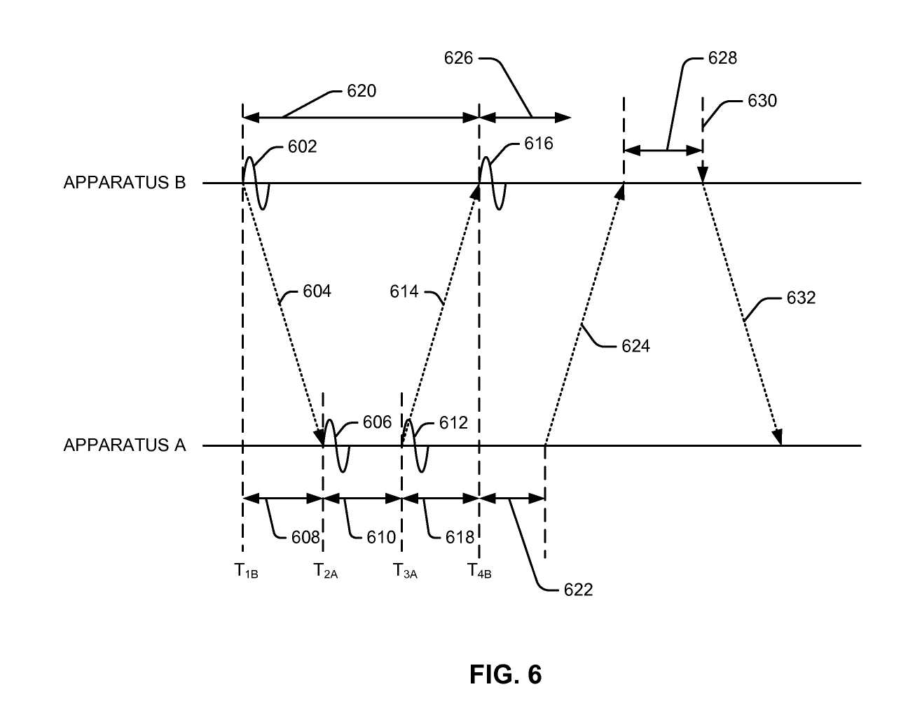

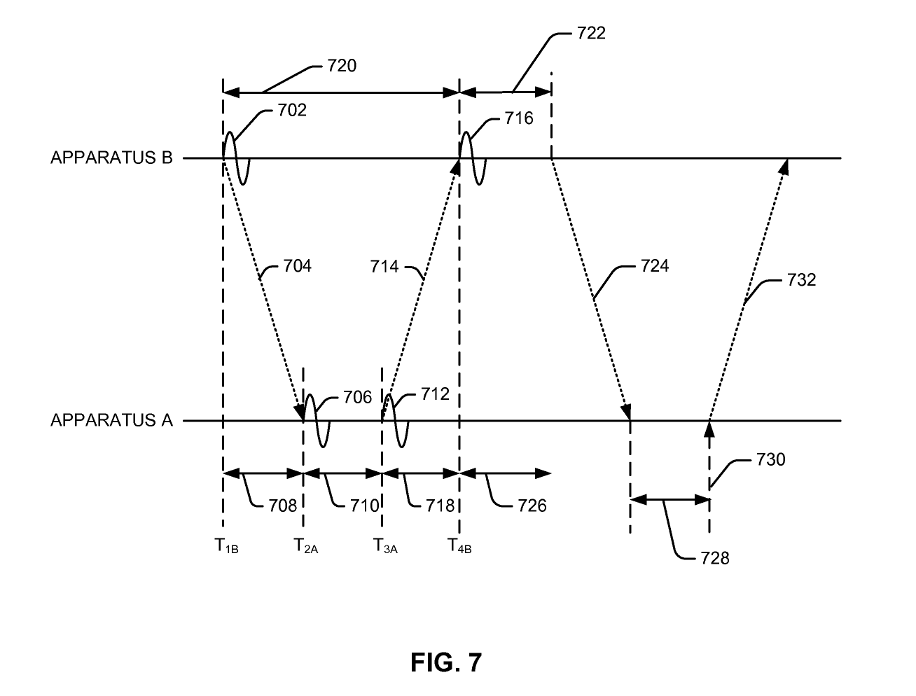

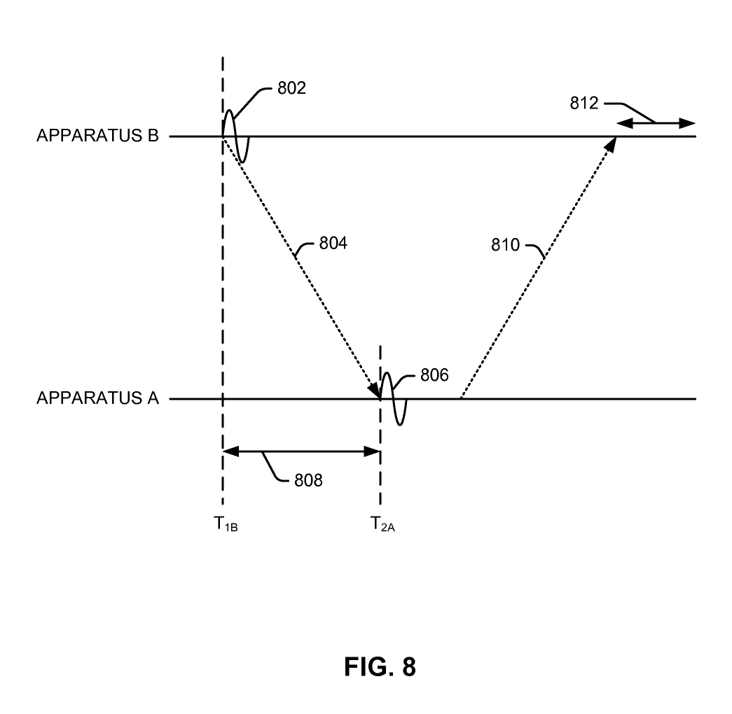

As mentioned above, the teachings herein are used in conjunction with impulse-based ranging in some cases. FIGS. 6-8 illustrate examples of pulse signaling and message flows for different ranging operations. In particular, FIGS. 6 and 7 illustrate sample signaling flows for two different two-way ranging scenarios, while FIG. 8 illustrates sample signaling flow for a one-way ranging operation.

Referring initially to FIG. 6, an apparatus B determines the distance to an apparatus A based on a round-trip time associated with pulses transmitted by the apparatuses. In this example, ranging operations are offloaded from the apparatus A to the apparatus B.

The pulses of FIG. 6 are depicted in a simplified form for purposes of illustration. Here, the apparatus B generates a pulse 602 that is transmitted over-the-air (as represented by the dashed line 604) to the apparatus A. This pulse is received at the apparatus A (as represented by a pulse 606) after a propagation time represented by the time arrow 608. Following a turnaround time period (as represented by the time arrow 610) after receiving the pulse 606, the apparatus A generates a pulse 612 that is transmitted over-the-air (as represented by the dashed line 614) to the apparatus B. This pulse is received at the apparatus B (as represented by a pulse 616) after a propagation time represented by the time arrow 618.

Each apparatus generates a timing indication (hereafter referred to, for convenience, as a timestamp) associated with the transmission and reception of these pulses. For example, the apparatuses A and B record transmit timestamps at T_{3A} and T_{1B}, respectively. In addition, the apparatus B determines a receive timestamp at T_{4B} as discussed below.

However, the apparatus A does not determine a receive timestamp at T_{2A} since this operation is offloaded to the apparatus B. As discussed herein, this operation is offloaded to the apparatus B so that the apparatus A will not have to perform some or all of the intensive processing that may be required to identify the time of arrival of the pulse 606. As discussed in more detail below for FIG. 9, a received signal may be relatively complex due to multipath reflections. For example, the received signal may comprise a composite signal that includes multiple versions of the transmitted signal. In such a case, a distance calculation that is based on a multipath component of the received signal may not be sufficiently accurate (e.g., to provide sub-meter ranging accuracy). Consequently, it may be desirable to identify a line of sight (LOS) path signal component of the composite received signal to determine the distance between the apparatuses with sufficient accuracy. However, as discussed below, the identification of this LOS component may involve intensive signal processing.

In the example of FIG. 6, as represented by the time arrow 622, the apparatus A optionally compresses the sample data generated based on the received pulse 606. As represented by the dashed line 624, the apparatus A then sends to the apparatus B: the raw data (optionally compressed), the associated sample timing information (e.g., one or more timestamps indicative of the sampling times), and an indication of T_{3A} (e.g., the timestamp recorded at T_{3A}) or an indication of the turnaround time period represented by the time arrow 610.

The apparatus A may send an indication of the turnaround time period in situations where the clocks of the apparatuses A and B are not synchronized. In some cases, this indication comprises an approximation (e.g., an initial estimate) of the time duration represented by the time arrow 610. For example, the apparatus A may send an indication of the time period from the time of a designated sample of the sample data (from the pulse 606) to the time at which the pulse 612 was transmitted. Note, however, that the time of the designated sample may not correspond to the time of the leading edge of the pulse 606. Hence, the apparatus B may process the received raw data to determine a time of arrival of the leading edge of the pulse 606 and correlate this time of arrival to the time of the designated sample. In this way, the apparatus B may determine a more precise estimate of the turnaround time (i.e., T_{2A} to T_{3A}).

Accordingly, as represented by the time arrow 626, upon receipt of the pulse 616, the apparatus B commences ranging calculations. Initially, the apparatus B determines (e.g., estimates) T_{4B} based on the received pulse 616. In addition, based on the compressed data received from the apparatus A (as represented by the line 624), the apparatus B determines T_{2A} as represented by the time arrow 628 (e.g., in the manner discussed above).

Thus at the time represented by the arrow 630, the apparatus B will have T_{1B}, T_{2A}, T_{3A}, and T_{4B}, and can thus determine the distance between the apparatuses A and B. Based on these timestamps, a propagation delay T_{P} (e.g., corresponding to the time arrow 608 or 618) may be computed. For example, a total round-trip time (represented by the time arrow 620) may be determined from T_{1B} and T_{4B} and the turnaround time from T_{2A} and T_{3A}. The round-trip signal propagation time 2T_{P} is calculated according to: 2T_{P}=(T_{4B}−T_{1B})−(T_{3A}−T_{2A}). The apparatus B calculates the distance between the apparatuses A and B based on T_{P} as discussed above. In addition, as represented by the dashed arrow 632, in some implementations, the apparatus B sends in indication of the distance and/or other related information to the apparatus A.

Referring now to FIG. 7, in this example, an apparatus A determines the distance to an apparatus B based on a round-trip time associated with pulses transmitted by the apparatuses. Here, ranging operations are offloaded from the apparatus B to the apparatus A.

The apparatus B generates a pulse 702 that is transmitted over-the-air (as represented by the dashed line 704) to the apparatus A. This pulse is received at the apparatus A (as represented by a pulse 706) after a propagation time represented by the time arrow 708. Following a turnaround time period (as represented by the time arrow 710) after receiving the pulse 706, the apparatus A generates a pulse 712 that is transmitted over-the-air (as represented by the dashed line 714) to the apparatus B. This pulse is received at the apparatus B (as represented by a pulse 716) after a propagation time represented by the time arrow 718.

As in FIG. 6, each apparatus generates a timestamp associated with the transmission and reception of these pulses. The apparatuses A and B record transmit timestamps at T_{3A} and T_{1B}, respectively. In addition, the apparatus A determines a receive timestamp at T_{2A} as discussed below.

The apparatus B does not determine a receive timestamp at T_{4B} since this operation is offloaded to the apparatus A. As represented by the time arrow 722, the apparatus B optionally compresses the sample data generated based on the received pulse 716. As represented by the dashed line 724, the apparatus B sends to the apparatus A: the raw data (optionally compressed), sample timing information, and an indication of T_{1B} (e.g., the timestamp recorded at T_{1B}) or an indication of the total round-trip time represented by the time arrow 720.

The apparatus B may send an indication of the total round-trip time in situations where the clocks of the apparatuses A and B are not synchronized. In some cases, this indication comprises an approximation (e.g., an initial estimate) of the time represented by the time arrow 720. For example, the apparatus B may send an indication of the time period from the time at which the pulse 702 was transmitted to the time of a designated sample of the sample data (from the pulse 716). The time of the designated sample may not, however, correspond to the time of the leading edge of the pulse 716. Hence, the apparatus A may process the received raw data to determine a time of arrival of the leading edge of the pulse 716 and correlate this time of arrival to the time of the designated sample. In this way, the apparatus A may determine a more precise estimate of the total round-trip time (i.e., T_{1B} to T_{4B}).

Accordingly, as represented by the time arrow 726, the apparatus A commences the ranging calculations some time after the receipt of the pulse 706. Initially, the apparatus A determines T_{2A} based on the received pulse 706. In addition, based on the compressed data received from the apparatus B (as represented by the line 724), the apparatus A determines T_{4B} as represented by the time arrow 728.

At the time represented by the arrow 730, the apparatus A will have T_{1B}, T_{2A}, T_{3A}, and T_{4B}, and can thus determine the distance between the apparatuses A and B. For example, the apparatus will have the total round-trip time from T_{1B} and T_{4B} and the turnaround time from T_{2A} and T_{3A}. The apparatus A can then calculate the round-trip signal propagation time by subtracting the turnaround time from the total round-trip time, and calculate the distance based on the round-trip signal propagation time as discussed above. In addition, as represented by the dashed arrow 732, in some implementations, the apparatus A sends in indication of the distance and/or other related information to the apparatus B.

In the one-way ranging operation of FIG. 8, it is assumed that the timing of apparatuses A and B are synchronized. Thus, a time stamp generated by one apparatus may be directly used by the other apparatus to determine the signal propagation time T_{P}.

In the example of FIG. 8, ranging operations are offloaded from the apparatus A to the apparatus B. The apparatus B generates a pulse 802 that is transmitted over-the-air (as represented by the dashed line 804) to the apparatus A. This pulse is received at the apparatus A (as represented by a signal 806) after a propagation time represented by the time arrow 808.

The apparatus B records a transmit timestamp at T_{1B}. The apparatus A sends raw data (optionally compressed) and an associated timing indication (e.g., corresponding to sample times at the apparatus A) to the apparatus B as represented by the dashed line 810. As represented by the time arrow 812, the apparatus B determines T_{2A} based on the received raw data. The apparatus B will thus have T_{1B} and T_{2A}, and can determine the distance between the apparatuses A and B based on these synchronized timestamp values.

In some aspects, a relatively significant amount of processing may be employed to identify a time of arrival of a pulse in cases where highly accurate ranging precision is desired. For example, some implementations employ sophisticated leading edge detection algorithms to provide, for example, sub-nanosecond ranging accuracy (e.g., to provide accuracy within one foot or less).

FIG. 9 illustrates how leading edge detection may differ from conventional signal detection (e.g., which may be used by the apparatuses A and B for data communication operations). Here, the apparatus A sends a pulse 902 that is transmitted (as represented by arrow 904) to the apparatus B. The pulse 906 represents the received pulse at apparatus B. The received pulse 906 has a more complex shape than the transmitted pulse 902 due to multipath reflections (e.g., that result from the RF energy of the pulse 902 propagating from the apparatus A to the apparatus B over multiple reflective paths, where each of the paths is associated with a different signal propagation time). In conventional signal detection, the time of arrival attributed to a pulse may correspond to the time at which the strongest portion of the pulse (e.g., the greatest magnitude of the pulse) arrives at the apparatus. Thus, for data communication purposes, the time of arrival attributed to the pulse 906 may be associated with point 908. Consequently, for a single path channel (e.g., a channel that does not introduce multipath components), an optimum threshold for determining time of arrival of a signal may be defined based on the maximum magnitude of the input signal.

In contrast, in a multi-path scenario (e.g., where different components of a transmitted signal propagate over different paths and some of these components are reflected along their respective paths), the leading path (e.g., line of sight (LOS) path) of a pulse may or may not be the strongest path. For example, the LOS path may be attenuated by an obstruction in the path such that a reflected path (non-LOS path) may be the strongest path. Accordingly, a received signal may have multiple lobes where a leading lobe (e.g., a lobe associated with the LOS path) may have a lower peak amplitude than a later lobe (e.g., a lobe associated with one or more reflected paths). Similarly, a received signal may have multiple signal path components (but not have readily distinguishable lobes) where a leading signal path component may have a lower peak amplitude than the overall signal. Since the leading path may be weaker than other paths under any of these circumstances, detection of the strongest signal path may not identify the leading edge of the pulse. In view of the above, to determine the signal propagation time with a high degree of accuracy for ranging, it is desirable to locate the leading edge 910 of the pulse 906 because the leading edge 910 is associated with the LOS path. Here, it should be appreciated that the LOS path is the shortest path between the apparatuses and, hence, corresponds to the actual distance between the apparatuses (in contrast with a reflected path that corresponds to a longer distance). However, precise leading edge detection algorithms tend to be more computationally complex than peak detection algorithms or other similar algorithms that could be used to identify timing of a pulse. Consequently, it is advantageous in some cases to use the techniques taught herein to offload from one ranging apparatus to another ranging apparatus some of the complex processing involved in determining a leading edge.

To identify a leading edge under multipath conditions, an apparatus should generate a sufficient quantity of samples and use a sampling rate that is sufficiently high to capture the complexity of a received pulse. Using the pulse 906 as an example, the sampling window used by the apparatus should be sufficiently wide to ensure that the leading edge 910 is sampled. For example, an apparatus that receives a pulse may sample over an entire period of time during which a received ranging pulse is expected (e.g., based on timing windows and time hopping definitions established when two apparatuses initiate a ranging operation). In addition, the sampling rate should be high enough to ensure that the leading edge 910 is distinguishable from other components of the pulse 906. For example, in some cases, the sampling rate is selected such that the different lobes of the pulse 906 may be identified from the raw data that results from the sampling. In this way, the apparatus that receives the raw data will be able to effectively isolate the leading edge of the pulse 906 and determine the time of arrival of that leading edge.

In some aspects, distance determination may involve processing several received pulses to identify a leading edge associated with those pulses. For example, a preliminary timestamp may be generated upon reception of a first pulse of a set of pulses. All of the pulses of the set may then be processed to assist in determining (e.g., estimating) a leading edge location and timing for these pulses (e.g., the average location and timing of a leading edge). The preliminary timestamp for the first pulse may then be adjusted based on the leading edge information for the set to provide a final time-of-arrival estimate.

FIG. 10 illustrates several sample components (represented by corresponding blocks) that may be incorporated into an apparatus 1002 and an apparatus 1004 (e.g., corresponding to the apparatus 104 and the apparatus 102 of FIG. 1, respectively) to perform ranging operations as taught herein. It should be appreciated that these components may be implemented in different types of apparatuses in different implementations (e.g., in an ASIC, in a system on a chip (SoC), etc.). The described components also may be incorporated into other nodes in a communication system. For example, other nodes in a system may include components similar to those described for the apparatus 1002 to provide similar functionality. Also, a given node may contain one or more of the described components. For example, an apparatus may include multiple transceiver components that enable the apparatus to operate on multiple carriers and/or communicate via different technologies.

The apparatus 1002 and the apparatus 1004 each include at least one wireless communication device (represented by the wireless communication devices 1006 and 1008) for communicating with other nodes via at least one designated radio access technology. The wireless communication device 1006 includes at least one transmitter 1010 for sending signals (e.g., messages, indications, information, data, estimates, and so on) and at least one receiver 1012 for receiving signals and sampling signals. Similarly, the wireless communication device 1008 includes at least one transmitter 1014 for sending signals and at least one receiver 1016 for receiving signals and sampling signals.

The apparatus 1002 and the apparatus 1004 each include other components that may be used in conjunction with ranging operations as taught herein. For example, the apparatus 1002 includes a processing system 1018 for providing functionality relating to ranging operations (e.g., elect to transmit generated data instead of an estimate of a time of arrival, determine an initial estimate of a time of reception, transition from a low power state to a high power state, transition from the high power state back to the low power state, and so on) and for providing other processing functionality. Similarly, the apparatus 1004 includes a processing system 1020 for providing functionality relating to ranging operations (e.g., determine a distance, decompress received data, select a ranging procedure, trigger the transmission of a signal, and so on) and for providing other processing functionality. The apparatus 1002 and the apparatus 1004 include respective memory components 1022 and 1024 (e.g., each including a memory device) for maintaining information (e.g., information, thresholds, parameters, and so on). In addition, the apparatuses 1002 and 1004 include user interface devices 1026 and 1028, respectively, for providing indications (e.g., audible and/or visual indications) to a user and/or for receiving user input (e.g., upon user actuation of a sensing device such a keypad, a touch screen, a microphone, and so on).

For convenience the apparatuses 1002 and 1004 are shown in FIG. 10 as including components that may be used in the various examples described herein. In practice, the illustrated blocks may have different functionality in different implementations. For example, the functionality of the block 1018 may be different in an implementation that employs two-way ranging as compared to an implementation that employs one-way ranging.

The components of FIG. 10 may be implemented in various ways. In some implementations, the components of FIG. 10 are implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 1006, 1018, 1022, and 1026 may be implemented by processor and memory component(s) of the apparatus 1002 (e.g., by execution of appropriate code and/or by appropriate configuration of processor components). Similarly, some or all of the functionality represented by blocks 1008, 1020, 1024, and 1028 may be implemented by processor and memory component(s) of the apparatus 1004 (e.g., by execution of appropriate code and/or by appropriate configuration of processor components).

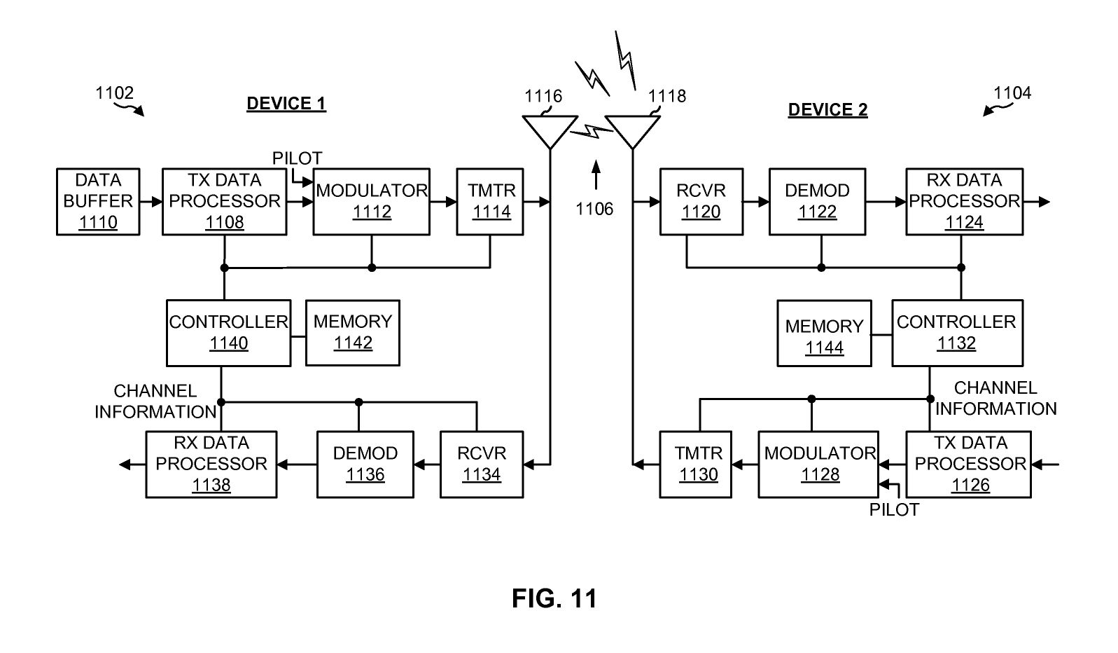

The teachings herein may be incorporated into a device employing various components for communicating with at least one other device. FIG. 11 depicts several sample components for enabling communication between devices. Here, a first device 1102 and a second device 1104 are configured to communicate via a wireless communication link 1106 over a suitable medium.

Initially, components involved in sending information from the device 1102 to the device 1104 (e.g., via a link) will be treated. A transmit (“TX”) data processor 1108 receives traffic data (e.g., data packets) from a data buffer 1110 or some other suitable component. The transmit data processor 1108 processes (e.g., encodes, interleaves, and symbol maps) each data packet based on a selected coding and modulation scheme, and provides data symbols. In general, a data symbol is a modulation symbol for data, and a pilot symbol is a modulation symbol for a pilot (which is known a priori). A modulator 1112 receives the data symbols, pilot symbols, and possibly signaling for the link, and performs modulation (e.g., OFDM or some other suitable modulation) and/or other processing as specified by the system, and provides a stream of output chips. A transmitter (“TMTR”) 1114 processes (e.g., converts to analog, filters, amplifies, and frequency upconverts) the output chip stream and generates a modulated signal, which is then transmitted from an antenna 1116.

The modulated signals transmitted by the device 1102 (along with signals from other devices in communication with the device 1104) are received by an antenna 1118 of the device 1104. A receiver (“RCVR”) 1120 processes (e.g., conditions and digitizes) the received signal from the antenna 1118 and provides received samples. A demodulator (“DEMOD”) 1122 processes (e.g., demodulates and detects) the received samples and provides detected data symbols, which may be a noisy estimate of the data symbols transmitted to the device 1104 by the other device(s). A receive (“RX”) data processor 1124 processes (e.g., symbol demaps, deinterleaves, and decodes) the detected data symbols and provides decoded data associated with each transmitting device (e.g., device 1102).

Components involved in sending information from the device 1104 to the device 1102 (e.g., via a link) will be now be treated. At the device 1104, traffic data is processed by a transmit (“TX”) data processor 1126 to generate data symbols. A modulator 1128 receives the data symbols, pilot symbols, and signaling for the link, performs modulation (e.g., OFDM or some other suitable modulation) and/or other pertinent processing, and provides an output chip stream, which is further conditioned by a transmitter (“TMTR”) 1130 and transmitted from the antenna 1118. In some implementations signaling for the link may include power control commands and other information (e.g., relating to a communication channel) generated by a controller 1132 for all devices (e.g. terminals) transmitting on the link to the device 1104.

At the device 1102, the modulated signal transmitted by the device 1104 is received by the antenna 1116, conditioned and digitized by a receiver (“RCVR”) 1134, and processed by a demodulator (“DEMOD”) 1136 to obtain detected data symbols. A receive (“RX”) data processor 1138 processes the detected data symbols and provides decoded data for the device 1102 and the link signaling. A controller 1140 may receive power control commands and other information to control data transmission and to control transmit power on the link to the device 1104.

The controllers 1140 and 1132 direct various operations of the device 1102 and the device 1104, respectively. For example, a controller may determine an appropriate filter, reporting information about the filter, and decode information using a filter. Data memories 1142 and 1144 may store program codes and data used by the controllers 1140 and 1132, respectively.

A wireless device may include various components that perform functions based on signals that are transmitted by or received at the wireless device. For example, a wireless headset may include a transducer configured to provide an audio output based on data received via the receiver. A wireless watch may include a user interface configured to provide an indication based on data received via the receiver. A wireless sensing device may include a sensor configured to provide data to be transmitted via the transmitter.

A wireless device may communicate via one or more wireless communication links that are based on or otherwise support any suitable wireless communication technology. For example, in some aspects a wireless device may associate with a network. In some aspects the network may comprise a personal area network (e.g., supporting a wireless coverage area on the order of 30 meters) or a body area network (e.g., supporting a wireless coverage area on the order of 10 meters) implemented using ultra-wideband technology or some other suitable technology. In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components that may include various components (e.g., signal generators and signal processors) that facilitate communication over a wireless medium.

In some aspects a wireless device may communicate via an impulse-based wireless communication link. For example, an impulse-based wireless communication link may utilize ultra-wideband pulses that have a relatively short length (e.g., on the order of a few nanoseconds or less) and a relatively wide bandwidth. In some aspects the ultra-wideband pulses may have a fractional bandwidth on the order of approximately 20% or more and/or have a bandwidth on the order of approximately 500 MHz or more.

The teachings herein may be incorporated into (e.g., implemented within or performed by) a variety of apparatuses (e.g., devices). For example, one or more aspects taught herein may be incorporated into a phone (e.g., a cellular phone), a personal data assistant (PDA), an entertainment device (e.g., a music or video device), a headset (e.g., headphones, an earpiece, etc.), a microphone, a medical sensing device (e.g., a sensor such as a biometric sensor, a heart rate monitor, a pedometer, an EKG device, a smart bandage, a vital signal monitor, etc.), a user I/O device (e.g., a watch, a remote control, a switch such as a light switch, a keyboard, a mouse, etc.), an environment sensing device (e.g., a tire pressure monitor), a monitor that may receive data from the medical or environment sensing device, a computer, a point-of-sale device, an entertainment device, a hearing aid, a set-top box, a gaming device, or any other suitable device. The communication devices described herein may be used in any type of sensing application, such as for sensing automotive, athletic, and physiological (medical) responses. Any of the disclosed aspects of the disclosure may be implemented in many different devices. For example, in addition to medical applications as discussed above, the aspects of the disclosure may be applied to health and fitness applications. Additionally, the aspects of the disclosure may be implemented in shoes for different types of applications. There are other multitudes of applications that may incorporate any aspect of the disclosure as described herein.

These devices may have different power and data requirements. In some aspects, the teachings herein may be adapted for use in low power applications (e.g., through the use of an impulse-based signaling scheme and low duty cycle modes) and may support a variety of data rates including relatively high data rates (e.g., through the use of high-bandwidth pulses).

In some aspects a wireless device may comprise an access device (e.g., an access point) for a communication system. Such an access device may provide, for example, connectivity to another network (e.g., a wide area network such as the Internet or a cellular network) via a wired or wireless communication link. Accordingly, the access device may enable another device (e.g., a wireless station) to access the other network or some other functionality. In addition, it should be appreciated that one or both of the devices may be portable or, in some cases, relatively non-portable. Also, it should be appreciated that a wireless device also may be capable of transmitting and/or receiving information in a non-wireless manner (e.g., via a wired connection) via an appropriate communication interface.

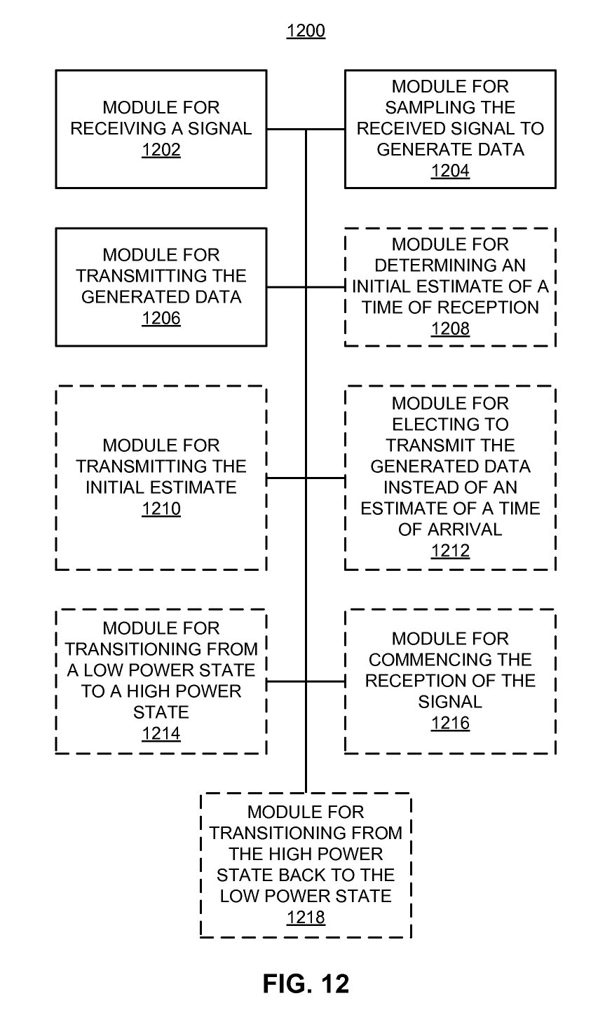

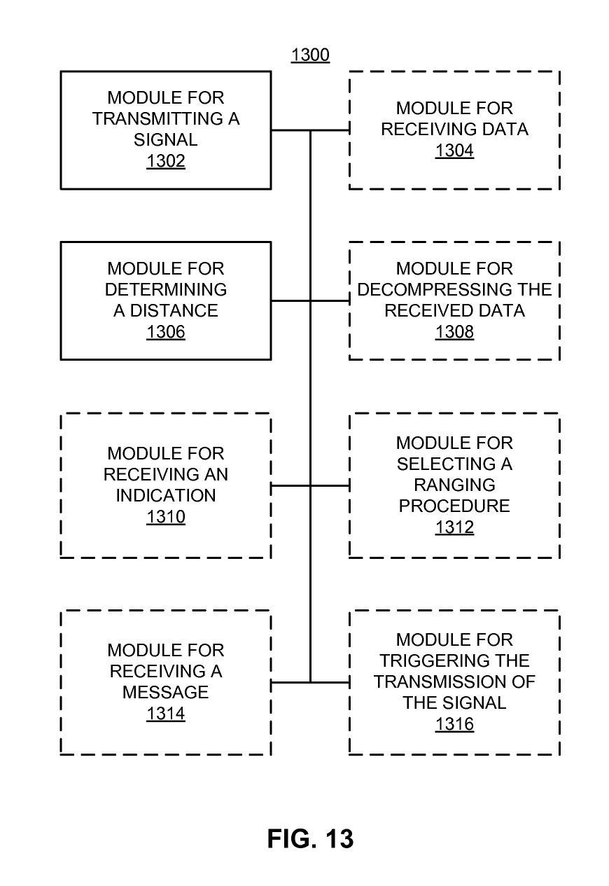

The components described herein may be implemented in a variety of ways. Referring to FIGS. 12 and 13, apparatuses 1200 and 1300 are represented as a series of interrelated functional blocks that may represent functions implemented by hardware, software, or a combination of hardware and software. For example, the blocks may be implemented by one or more integrated circuits (e.g., an ASIC) or may be implemented in some other manner as taught herein. As discussed herein, an integrated circuit may include a processor, software, other components, or some combination thereof.

The apparatuses 1200 and 1300 include one or more modules that may perform one or more of the functions described above with regard to various figures. For example, a module for receiving a signal 1202 may correspond to, for example, a communication device as discussed herein (e.g., transceiver 112, receiver 1012). A module for sampling the received signal to generate data 1204 may correspond to, for example, a communication device as discussed herein (e.g., transceiver 112, receiver 1012). A module for transmitting the generated data 1206 may correspond to, for example, a communication device as discussed herein (e.g., transceiver 112, transmitter 1010). A module for determining an initial estimate of a time of reception 1208 may correspond to, for example, a processing system as discussed herein (e.g., processing system 1018, controller 1140). A module for transmitting the initial estimate 1210 may correspond to, for example, a communication device as discussed herein (e.g., transceiver 112, transmitter 1010). A module for electing to transmit the generated data instead of an estimate of a time of arrival 1212 may correspond to, for example, a processing system as discussed herein (e.g., processing system 1018, controller 1140). A module for transitioning from a low power state to a high power state 1214 may correspond to, for example, a processing system as discussed herein (e.g., processing system 1018, controller 1140). A module for commencing the reception of the signal 1216 may correspond to, for example, a processing system as discussed herein (e.g., processing system 1018, controller 1140). A module for transitioning from the high power state back to the low power state 1218 may correspond to, for example, a processing system as discussed herein (e.g., processing system 1018, controller 1140).

A module for transmitting a signal 1302 may correspond to, for example, a communication device as discussed herein (e.g., transceiver 110, transmitter 1014). A module for receiving data 1304 may correspond to, for example, a communication device as discussed herein (e.g., transceiver 110, receiver 1016). A module for determining a distance 1306 may correspond to, for example, a processing system as discussed herein (e.g., processing system 1020, controller 1132). A module for decompressing the received data 1308 may correspond to, for example, a processing system as discussed herein (e.g., processing system 1020, controller 1132). A module for receiving an indication 1310 may correspond to, for example, a communication device as discussed herein (e.g., transceiver 110, receiver 1016). A module for selecting a ranging procedure 1312 may correspond to, for example, a processing system as discussed herein (e.g., processing system 1020, controller 1132). A module for receiving a message 1314 may correspond to, for example, a communication device (e.g., transceiver 110, receiver 1016) as discussed herein. A module for triggering the transmission of the signal 1316 may correspond to, for example, a processing system as discussed herein (e.g., processing system 1020, controller 1132).

As noted above, in some aspects these modules may be implemented via appropriate processor components. These processor components may in some aspects be implemented, at least in part, using structure as taught herein. In some aspects a processor may be configured to implement a portion or all of the functionality of one or more of these modules. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. In some aspects one or more of any components represented by dashed boxes are optional. Furthermore, in some aspects, the modules may be implemented as application specific hardware (e.g., one or more integrated circuit chips, one or more ASICs, etc.).

As noted above, the apparatuses 1200 and 1300 may comprise one or more integrated circuits. For example, in some aspects a single integrated circuit may implement the functionality of one or more of the illustrated components, while in other aspects more than one integrated circuit may implement the functionality of one or more of the illustrated components.

In addition, the components and functions represented by FIGS. 12 and 13 as well as other components and functions described herein, may be implemented using any suitable means. Such means also may be implemented, at least in part, using corresponding structure as taught herein. For example, the components described above in conjunction with the “module for” components of FIGS. 12 and 13 also may correspond to similarly designated “means for” functionality. Thus, in some aspects one or more of such means may be implemented using one or more of processor components, integrated circuits, or other suitable structure as taught herein.

Also, it should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes (e.g., executable by at least one computer) relating to one or more of the aspects of the disclosure. In some aspects a computer program product may comprise packaging materials.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media such as a storage media). In addition, in some aspects computer readable medium may comprise transitory computer readable medium (e.g., comprising a signal). Combinations of the above should also be included within the scope of computer-readable media. It should be appreciated that a computer-readable medium may be implemented in any suitable computer-program product.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An apparatus for wireless communication, comprising:
a receiver configured to receive a signal from another apparatus, and further configured to sample the received signal to generate data that is representative of timing and magnitude of the received signal; and
a transmitter configured to transmit the generated data to the other apparatus to enable the other apparatus to determine a distance between the apparatus and the other apparatus.

2. The apparatus of claim 1, wherein:
the generated data represents a plurality of samples of the received signal; and
the generated data comprises at least one timestamp corresponding to timing of the plurality of samples.

3. The apparatus of claim 2, wherein the received signal comprises a pulse.

4. The apparatus of claim 1, wherein the generation of the data comprises compressing a set of data obtained as a result of the sampling.

5. The apparatus of claim 4, wherein the set of data comprises: sample data representative of a plurality of samples of the received signal, at least one timestamp corresponding to timing of a plurality of samples of the received signal, or sample data representative of a plurality of samples of the received signal and at least one timestamp corresponding to timing of the plurality of samples.

6. The apparatus of claim 1, wherein:
the apparatus further comprises a processing system configured to determine an initial estimate of a time of reception of the received signal; and
the transmitter is further configured to transmit the initial estimate to the other apparatus to enable the other apparatus to determine a more precise estimate of the time of reception of the received signal.

7. The apparatus of claim 1, wherein the apparatus further comprises a processing system configured to elect, based on a resource attribute of the apparatus, to transmit the generated data to the other apparatus instead of an estimate of a time of arrival of the signal at the apparatus.

8. The apparatus of claim 7, wherein the resource attribute relates to: a power resource, a processing resource, or power and processing resources.

9. The apparatus of claim 1, wherein the apparatus further comprises a processing system configured to:
transition the first apparatus from a low power state to a high power state; and
commence the reception of the signal as a result of the transition from the low power state to the high power state.

10. The apparatus of claim 9, wherein the processing system is further configured to transition the apparatus from the high power state back to the low power state as a result of transmitting the generated data.

11. The apparatus of claim 1, wherein, to represent the timing of the received signal, the generated data comprises at least one time value indicative of when the sampling occurred.

12. The apparatus of claim 1, wherein, to represent the magnitude of the received signal, the generated data comprises a plurality of amplitude values of samples generated by the sampling.

13. The apparatus of claim 1, wherein, to represent the magnitude of the received signal, the generated data comprises a plurality of power values of samples generated by the sampling.

14. A method for wireless communication, comprising:
receiving a signal from a second apparatus at a first apparatus;
sampling the received signal to generate data that is representative of timing and magnitude of the received signal; and
transmitting the generated data from the first apparatus to the second apparatus to enable the second apparatus to determine a distance between the first apparatus and the second apparatus.

15. The method of claim 14, wherein:
the generated data represents a plurality of samples of the received signal; and
the generated data comprises at least one timestamp corresponding to timing of the plurality of samples.

16. The method of claim 15, wherein the received signal comprises a pulse.

17. The method of claim 14, wherein the generation of the data comprises compressing a set of data obtained as a result of the sampling.

18. The method of claim 17, wherein the set of data comprises: sample data representative of a plurality of samples of the received signal, at least one timestamp corresponding to timing of a plurality of samples of the received signal, or sample data representative of a plurality of samples of the received signal and at least one timestamp corresponding to timing of the plurality of samples.

19. The method of claim 14, further comprising:
determining, at the first apparatus, an initial estimate of a time of reception of the received signal; and
transmitting the initial estimate from the first apparatus to the second apparatus to enable the second apparatus to determine a more precise estimate of the time of reception of the received signal.

20. The method of claim 14, further comprising electing, based on a resource attribute of the first apparatus, to transmit the generated data to the second apparatus instead of an estimate of a time of arrival of the signal at the first apparatus.

21. The method of claim 20, wherein the resource attribute relates to: a power resource, a processing resource, or power and processing resources.

22. The method of claim 14, further comprising:
transitioning the first apparatus from a low power state to a high power state; and
commencing the reception of the signal at the first apparatus as a result of the transition from the low power state to the high power state.

23. The method of claim 22, further comprising transitioning the first apparatus from the high power state back to the low power state as a result of transmitting the generated data.

24. The method of claim 14, wherein, to represent the timing of the received signal, the generated data comprises at least one time value indicative of when the sampling occurred.

25. The method of claim 14, wherein, to represent the magnitude of the received signal, the generated data comprises a plurality of amplitude values of samples generated by the sampling.

26. The method of claim 14, wherein, to represent the magnitude of the received signal, the generated data comprises a plurality of power values of samples generated by the sampling.

27. An apparatus for wireless communication, comprising:
means for receiving a signal from another apparatus;
means for sampling the received signal to generate data that is representative of timing and magnitude of the received signal; and
means for transmitting the generated data to the other apparatus to enable the other apparatus to determine a distance between the apparatus and the other apparatus.

28. The apparatus of claim 27, wherein:
the generated data represents a plurality of samples of the received signal; and
the generated data comprises at least one timestamp corresponding to timing of the plurality of samples.

29. The apparatus of claim 28, wherein the received signal comprises a pulse.

30. The apparatus of claim 27, wherein the generation of the data comprises compressing a set of data obtained as a result of the sampling.

31. The apparatus of claim 30, wherein the set of data comprises: sample data representative of a plurality of samples of the received signal, at least one timestamp corresponding to timing of a plurality of samples of the received signal, or sample data representative of a plurality of samples of the received signal and at least one timestamp corresponding to timing of the plurality of samples.

32. The apparatus of claim 27, further comprising:
means for determining an initial estimate of a time of reception of the received signal; and
means for transmitting the initial estimate to the other apparatus to enable the other apparatus to determine a more precise estimate of the time of reception of the received signal.

33. The apparatus of claim 27, further comprising means for electing, based on a resource attribute of the apparatus, to transmit the generated data to the other apparatus instead of an estimate of a time of arrival of the signal at the apparatus.

34. The apparatus of claim 33, wherein the resource attribute relates to: a power resource, a processing resource, or power and processing resources.

35. The apparatus of claim 27, further comprising:
means for transitioning the apparatus from a low power state to a high power state; and
means for commencing the reception of the signal as a result of the transition from the low power state to the high power state.

36. The apparatus of claim 35, further comprising means for transitioning the apparatus from the high power state back to the low power state as a result of transmitting the generated data.

37. The apparatus of claim 27, wherein, to represent the timing of the received signal, the generated data comprises at least one time value indicative of when the sampling occurred.

38. The apparatus of claim 27, wherein, to represent the magnitude of the received signal, the generated data comprises a plurality of amplitude values of samples generated by the sampling.

39. The apparatus of claim 27, wherein, to represent the magnitude of the received signal, the generated data comprises a plurality of power values of samples generated by the sampling.

40. A computer-program product for wireless communication, comprising:
computer-readable medium comprising codes executable to:
receive a signal from a second apparatus at a first apparatus;
sample the received signal to generate data that is representative of timing and magnitude of the received signal; and
transmit the generated data from the first apparatus to the second apparatus to enable the second apparatus to determine a distance between the first apparatus and the second apparatus.

41. An apparatus for wireless communication, comprising:
a transmitter configured to transmit a signal to another apparatus;
a receiver configured to receive data from the other apparatus, wherein the received data is representative of timing and magnitude of the signal as received by the other apparatus; and
a processing system configured to determine a distance between the apparatus and the other apparatus based on the received data.

42. The apparatus of claim 41, wherein:
the received data represents a plurality of samples of the signal as received by the other apparatus; and
the received data comprises at least one timestamp corresponding to timing of the plurality of samples.

43. The apparatus of claim 42, wherein the signal comprises a pulse.

44. The apparatus of claim 41, wherein the determination of the distance comprises:
determining a time of arrival of the signal at the other apparatus based on the received data;
determining a signal propagation time based on a time of the transmission of the signal from the apparatus and the determined time of arrival; and
determining the distance based on the signal propagation time.

45. The apparatus of claim 41, wherein:
the processing system is further configured to decompress the received data; and
the determination of the distance based on the received data comprises processing the decompressed received data to determine a time of arrival of the signal at the other apparatus.

46. The apparatus of claim 45, wherein the received data comprises a compressed set of data based on: sample data representative of a plurality of samples of the signal, at least one timestamp corresponding to timing of a plurality of samples of the signal, or sample data representative of a plurality of samples of the signal and at least one timestamp corresponding to timing of the plurality of samples.

47. The apparatus of claim 41, wherein:
the signal comprises a pulse; and
the determination of the distance comprises determining a time of arrival of a leading edge of the pulse at the other apparatus based on the received data.

48. The apparatus of claim 41, wherein:
the receiver is further configured to receive an indication that the other apparatus elects to transmit the data representative of timing and magnitude of the signal to the apparatus instead of an estimate of a time of arrival of the signal at the other apparatus; and
the processing system is further configured to, as a result of the receipt of the indication, selecting a ranging procedure that determines the distance based on the data representative of timing and magnitude of the signal rather than a received estimate of the time of arrival of the signal at the other apparatus.

49. The apparatus of claim 41, wherein:
the receiver is further configured to receive a message from the other apparatus, wherein the message indicates that the other apparatus has transitioned from a low power state to a high power state to commence a ranging operation; and
the processing system is further configured to trigger the transmission of the signal based on the receipt of the message.

50. The apparatus of claim 41, wherein, to represent the timing of the signal, the received data comprises at least one time value indicative of when the other apparatus sampled the signal.

51. The apparatus of claim 41, wherein, to represent the magnitude of the signal, the received data comprises a plurality of amplitude values of samples generated by the other apparatus sampling the signal.

52. The apparatus of claim 41, wherein, to represent the magnitude of the signal, the received data comprises a plurality of power values of samples generated by the other apparatus sampling the signal.

53. A method for wireless communication, comprising:
transmitting a signal from a second apparatus to a first apparatus;
receiving data from the first apparatus at the second apparatus, wherein the received data is representative of timing and magnitude of the signal as received by the first apparatus; and
determining a distance between the first apparatus and the second apparatus based on the received data.

54. The method of claim 53, wherein:
the received data represents a plurality of samples of the signal as received by the first apparatus; and
the received data comprises at least one timestamp corresponding to timing of the plurality of samples.

55. The method of claim 54, wherein the signal comprises a pulse.

56. The method of claim 53, wherein the determination of the distance comprises:
determining a time of arrival of the signal at the first apparatus based on the received data;
determining a signal propagation time based on a time of the transmission of the signal from the second apparatus and the determined time of arrival; and
determining the distance based on the signal propagation time.

57. The method of claim 53, further comprising decompressing the received data, wherein the determination of the distance based on the received data comprises processing the decompressed received data to determine a time of arrival of the signal at the first apparatus.

58. The method of claim 57, wherein the received data comprises a compressed set of data based on: sample data representative of a plurality of samples of the signal, at least one timestamp corresponding to timing of a plurality of samples of the signal, or sample data representative of a plurality of samples of the signal and at least one timestamp corresponding to timing of the plurality of samples.

59. The method of claim 53, wherein:
the signal comprises a pulse; and
the determination of the distance comprises determining a time of arrival of a leading edge of the pulse at the first apparatus based on the received data.

60. The method of claim 53, further comprising:
receiving an indication that the first apparatus elects to transmit the data representative of timing and magnitude of the signal to the second apparatus instead of an estimate of a time of arrival of the signal at the first apparatus; and
as a result of the receipt of the indication, selecting a ranging procedure that determines the distance based on the data representative of timing and magnitude of the signal rather than a received estimate of the time of arrival of the signal at the first apparatus.

61. The method of claim 53, further comprising:
receiving a message from the first apparatus at the second apparatus, wherein the message indicates that the first apparatus has transitioned from a low power state to a high power state to commence a ranging operation; and
triggering the transmission of the signal based on the receipt of the message.

62. The method of claim 53, wherein, to represent the timing of the signal, the received data comprises at least one time value indicative of when the first apparatus sampled the signal.

63. The method of claim 53, wherein, to represent the magnitude of the signal, the received data comprises a plurality of amplitude values of samples generated by the first apparatus sampling the signal.

64. The method of claim 53, wherein, to represent the magnitude of the signal, the received data comprises a plurality of power values of samples generated by the first apparatus sampling the signal.

65. An apparatus for wireless communication, comprising:
means for transmitting a signal to another apparatus;
means for receiving data from the other apparatus, wherein the received data is representative of timing and magnitude of the signal as received by the other apparatus; and
means for determining a distance between the apparatus and the other apparatus based on the received data.

66. The apparatus of claim 65, wherein:
the received data represents a plurality of samples of the signal as received by the other apparatus; and
the received data comprises at least one timestamp corresponding to timing of the plurality of samples.

67. The apparatus of claim 66, wherein the signal comprises a pulse.

68. The apparatus of claim 65, wherein the determination of the distance comprises:
determining a time of arrival of the signal at the other apparatus based on the received data;
determining a signal propagation time based on a time of the transmission of the signal from the apparatus and the determined time of arrival; and
determining the distance based on the signal propagation time.

69. The apparatus of claim 65, further comprising means for decompressing the received data, wherein the determination of the distance based on the received data comprises processing the decompressed received data to determine a time of arrival of the signal at the other apparatus.

70. The apparatus of claim 69, wherein the received data comprises a compressed set of data based on: sample data representative of a plurality of samples of the signal, at least one timestamp corresponding to timing of a plurality of samples of the signal, or sample data representative of a plurality of samples of the signal and at least one timestamp corresponding to timing of the plurality of samples.

71. The apparatus of claim 65, wherein:
the signal comprises a pulse; and
the determination of the distance comprises determining a time of arrival of a leading edge of the pulse at the other apparatus based on the received data.

72. The apparatus of claim 65, further comprising:
means for receiving an indication that the other apparatus elects to transmit the data representative of timing and magnitude of the signal to the apparatus instead of an estimate of a time of arrival of the signal at the other apparatus; and
means for selecting, as a result of the receipt of the indication, a ranging procedure that determines the distance based on the data representative of timing and magnitude of the signal rather than a received estimate of the time of arrival of the signal at the other apparatus.

73. The apparatus of claim 65, further comprising:
means for receiving a message from the other apparatus, wherein the message indicates that the other apparatus has transitioned from a low power state to a high power state to commence a ranging operation; and
means for triggering the transmission of the signal based on the receipt of the message.

74. The apparatus of claim 65, wherein, to represent the timing of the signal, the received data comprises at least one time value indicative of when the other apparatus sampled the signal.

75. The apparatus of claim 65, wherein, to represent the magnitude of the signal, the received data comprises a plurality of amplitude values of samples generated by the other apparatus sampling the signal.

76. The apparatus of claim 65, wherein, to represent the magnitude of the signal, the received data comprises a plurality of power values of samples generated by the other apparatus sampling the signal.

77. A computer-program product for wireless communication, comprising:
computer-readable medium comprising codes executable to:
transmit a signal from a second apparatus to a first apparatus;
receive data from the first apparatus at the second apparatus, wherein the received data is representative of timing and magnitude of the signal as received by the first apparatus; and
determine a distance between the first apparatus and the second apparatus based on the received data.
